(19) United States
(12) Patent Application Publication
(10) Pub. No.: US 2009/0067817 A1
(43) Pub. Date: Mar. 12, 2009

(54) ERROR RECOVERY METHOD FOR RECORDING AUDIO-VIDEO INTERLEAVED FILE

(75) Inventors: Shun-Yu Chuang, Yunlin County (TW); Po-Wei Lin, Changhua County (TW); Ting-Jian Pan, Taipei City (TW)

Correspondence Address: J C PATENTS, INC., 4 VENTURE, SUITE 250, IRVINE, CA, 92618, US

(73) Assignee: SUNPLUS TECHNOLOGY CO., LTD., Hsinchu (TW)

(21) Appl. No.: 11/966,757

(22) Filed: Dec. 28, 2007

(30) Foreign Application Priority Data
Sep. 7, 2007 (TW) 96133458

(51) Int. Cl. H04N 7/26

(52) U.S. Cl. 386/124; 386/E05.001

(57) ABSTRACT

An error recovery method for recording an audio-video interleaved (AVI) file is provided. The AVI file includes a header chunk and a content chunk. First, the predetermined values of a plurality of recording information are respectively written into a plurality of corresponding fields in the header chunk and the content chunk, wherein the recording information is related to a video/audio length of the AVI file. Next, a multiplexed media data is written into the content chunk for recording the AVI file. After the AVI file recording is finished, the corresponding fields in the header chunk and the content chunk are corrected according to the actual values of the recording information. Thereby, even if the recording process is abnormally terminated, the AVI file can still be normally accessed for it has a complete and legitimate structure.

### CROSS-REFERENCE TO RELATED APPLICATION

This application claims the priority benefit of Taiwan application serial no. 96133458, filed on Sep. 7, 2007. The entirety of the above-mentioned patent application is hereby incorporated by reference herein and made a part of this specification.

### BACKGROUND OF THE INVENTION

1. Field of the Invention

The present invention generally relates to an error recovery method for recording an audio-video interleaved (AVI) file, in particular, to a method for recording a plurality of recording information of an AVI file so that the AVI file can be accessed normally even if the recording process is abnormally terminated.

2. Description of Related Art

Along with the development of multimedia technology, image tracking has been made possible in a monitoring system (for example, a security system) through real-time recording. The recorded content in such a monitoring system is usually very important and therefore the requirement to the continuity of the recorded content is very high.

One of the most commonly used file formats in real-time recording is audio-video interleaved (AVI) file. Video/audio data in an AVI file is divided into many data chunks, and these data chunks are transmitted in an interleaved manner. Here the interleavingly transmitted data chunks are generally referred as multiplexed media data. Besides, an AVI file uses a resource interchange file format (RIFF) to store data; namely, a meta-format wherein data is stored in tagged chunks is adopted by an AVI file.

Generally speaking, a complete AVI file has a header adapting to the AVI specification and provided to a multimedia player for playing the AVI file. Thus, if the recording process of an AVI file is terminated by an abnormal interruption, such as a power failure, the video/audio content of the AVI file recorded before the power failure may not be played correctly by the multimedia player since the AVI file does not have a legitimate header for describing the structure of the AVI file.

FIG. 1 is a flowchart of a conventional method for recording an AVI file. Referring to FIG. 1, the initial information (for example, the sampling frequency of recording the audio) of the AVI file is usually set before the AVI file is recorded (step S101). While recording the AVI file, video/audio data is sequentially written into the AVI file (step S102), and whether the recording process is finished or not is determined (step S103). Video/audio data is continuously written into the AVI file if the recording process is not finished (step S102). The indices related to the video/audio data are sorted and a header is written into the AVI file according to the complete video/audio data if the recording process is finished (step S104).

However, in the method described above, the header is written into the AVI file according to the complete video/audio data after the recording process is finished, which means a correct header which is eventually written into the AVI file cannot be obtained during the recording process. If a power failure or other interruption occurs during the recording process, the video/audio data recorded in the AVI file before the occurrence of the power failure or interruption cannot be correctly played because there is no complete and legitimate header in the AVI file. Thereby, another method for recording an AVI file is provided, wherein the header is timely updated.

FIG. 2 is a flowchart of the conventional method for recording an AVI file. Referring to FIG. 2, this method includes following steps. The header is updated according to the recorded video/audio data (step S203) every time after a video/audio data is recorded (step S202). The header is corrected according to the complete video/audio data (step S205) after the recording process is finished (step S204). In this method, even the video/audio data recorded before the interruption can be correctly played by a multimedia player, the efficiency of the recording system is considerably reduced since the header in the AVI file is constantly changed along the content recorded in the AVI file.

### SUMMARY OF THE INVENTION

Accordingly, the present invention is directed to an error recovery method for recording an audio-video interleaved (AVI) file, wherein if the recording process is abnormally terminated by an interruption, the AVI file recorded before the interruption can be normally accessed by the recording system.

The present invention provides an error recovery method for recording an AVI file, wherein the AVI file includes a header chunk and a content chunk. According to the error recovery method, the predetermined values of a plurality of recording information are respectively written into a plurality of corresponding fields in the header chunk and the content chunk, wherein the recording information is related to a video/audio length of the AVI file. When a multiplexed media data is received, the multiplexed media data is written into the content chunk for recording the AVI file.

The present invention further provides an error recovery method for recording an AVI file, wherein the AVI file includes a header chunk and a content chunk. According to the error recovery method, the predetermined values of a plurality of recording information are respectively written into a plurality of corresponding fields in the header chunk and the content chunk, wherein the recording information is related to a video/audio length of the AVI file. When a multiplexed media data is received, the multiplexed media data is written into the content chunk for recording the AVI file. The corresponding fields in the header chunk and the content chunk are updated with a threshold value at intervals of a predetermined time, wherein the threshold value is greater than or equal to the values of the recording information calculated before next time the fields are updated.

According to an embodiment of the present invention, the error recovery method for recording the AVI file includes performing an initialization process to set initial information of the AVI file.

According to an embodiment of the present invention, the AVI file includes an index chunk, and the error recovery method for recording the AVI file further includes writing the chunk types of a plurality of sub-chunks in the content chunk and the offsets for playing the sub-chunks into the index chunk.

According to the present invention, the predetermined values of a plurality of recording information of an AVI file are written before recording the media data. Thereby, even if the recording process is terminated abnormally by an interruption, the AVI file recorded before the interruption can be accessed normally because the AVI file has a complete and legitimate structure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a conventional method for recording an AVI file.

FIG. 2 is a flowchart of another conventional method for recording an AVI file.

FIG. 3 is a structure diagram of an AVI file.

FIG. 4 illustrates a flowchart for recording an AVI file according to an embodiment of the present invention.

FIG. 5 is a flowchart of an error recovery method for recording an AVI file according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an error recovery method for recording an audio-video interleaved (AVI) file, wherein if the recording process is abnormally terminated by an interruption, the AVI file recorded before the interruption may still be normally accessed.

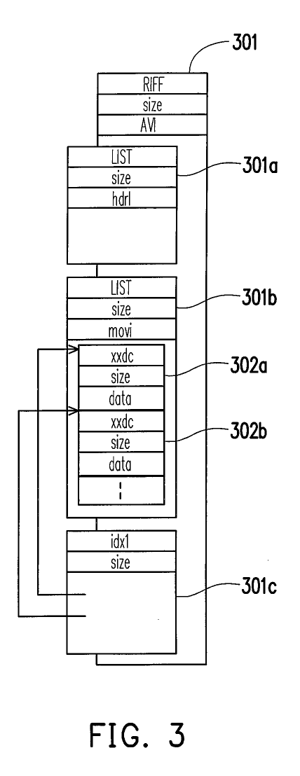

FIG. 3 is a structure diagram of an AVI file. Referring to FIG. 3, each AVI file is constructed on a resource interchange file format (RIFF) chunk, and the RIFF chunk includes a plurality of sub-chunks. A RIFF sub-chunk may be a LIST chunk or a regular sub-chunk, wherein the LIST chunk is such as a header chunk 301a or a content chunk 301b, and the regular sub-chunk is such as an index chunk 301c. A LIST chunk has the same structure as a RIFF chunk and may include the LIST chunks or the regular sub-chunks, but the regular sub-chunks cannot further include any sub-chunk.

A complete RIFF chunk 301 includes a header chunk 301a, a content chunk 301b, and an optional index chunk 301c. The header chunk 301a has a plurality of fields for recording the recording information, such as the RIFF size, the avih #frames, a video length (i.e. the frame number of a video data), and an audio length (the sample number of audio data) of the AVI file. The content chunk 301b is used for recording video/audio data and the size thereof.

The video/audio data is divided into a plurality of data chunks. For example, each video data chunk is a frame, and the data chunks are respectively recorded in the sub-chunks 302a and 302b (only 2 sub-chunks are described herein as example) in the content chunk 301b. The index chunk 301c records the offsets for playing the data chunks and the sizes of the data chunks, so that a desired data chunk may be quickly located while playing back, fast forwarding, or rewinding the video/audio data. In addition, the index chunk 301c may also record the chunk types of the data chunks, for example, an I (intra) frame of a video data chunk is recorded in the index chunk 301c.

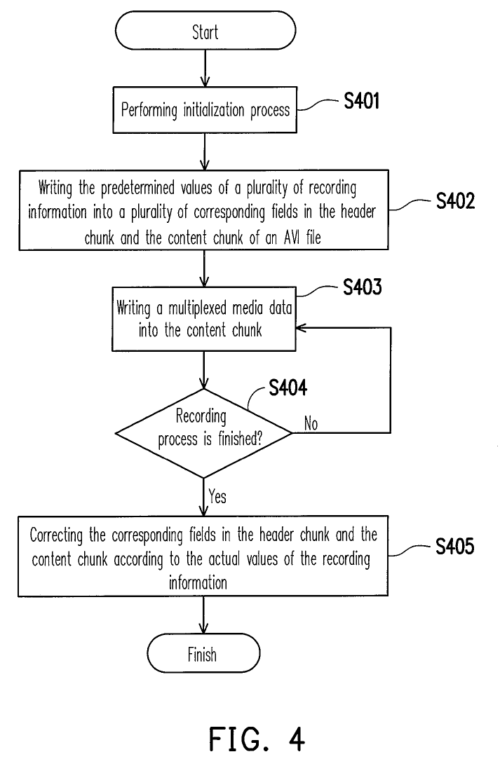

FIG. 4 illustrates a flowchart for recording an AVI file according to an embodiment of the present invention. Referring to FIG. 3 and FIG. 4, first, an initialization process is performed (step S401) to set the initial information (for example, the sampling frequency of the audio data or the compression format of the video data) of the AVI file. Next, the predetermined values of the recording information are written into the corresponding fields in the header chunk 301a and the content chunk 301b (step S402). The recording information may be any information related to a video/audio length of the AVI file, such as a video frame number, the size of the video/audio data, or an audio data sampling number.

In the present embodiment, the predetermined values of the recording information written into the header chunk 301a may be the size of the RIFF chunk (i.e. the size of the video/audio data), a video frame number, or an audio data sampling number, and the predetermined values of the recording information written into the content chunk 301b may be the size of the video/audio data. In a real recording system, the recording information is restricted by the corresponding fields specified in the specification of the AVI file. Thus, in the present embodiment, the predetermined values of the recording information are preferably the maximum values of the recording information as specified by the specification of the AVI file and optimally the maximum values of the recording information which can be recorded by the recording system or greater than or equal to the actual values of the recording information recorded by the recording system.

For example, the video frame rate specified by national television standards committee (NTSC) is about 30 frames/second. If a NTSC video/audio data is to be recorded and the video/audio length which can be recorded by the recording system is 3 hours, the maximum video frame number acceptable to the recording system is written into the fields corresponding to the video length and avih #frames in the header chunk 301a, namely, 3 hours×60 minutes/hour×60 seconds/minute×30 frames/second=324000 frames. The maximum audio data sample number acceptable to the recording system is written into the field corresponding to the audio length. Similarly, the maximum values acceptable to the recording system are written into the other fields. It should be understood by those skilled in the art that when a video/audio data conforming to the phase alternating line (PAL) is to be recorded, corresponding settings can be made according to the maximum frame rate specified by PAL.

Next, a multiplexed media data is written into the content chunk 301b to record the AVI file (step S403), and whether the recording process is finished or not is determined (step S404). If the recording process is not finished, the multiplexed media data is written into the content chunk 301b continuously (step S403); otherwise, if the recording process is finished, the corresponding fields in the header chunk 301a and the content chunk 301b are corrected according to the actual values of the recording information (step S405). Generally speaking, the chunk types of the sub-chunks (for example, the sub-chunks 302a and 302b) in the content chunk 301b and the offsets for playing the sub-chunks are also written into the index chunk 301c while writing the multiplexed media data into the content chunk 301b. Accordingly, the information recorded in the index chunk 301c is sorted after the recording process is finished.

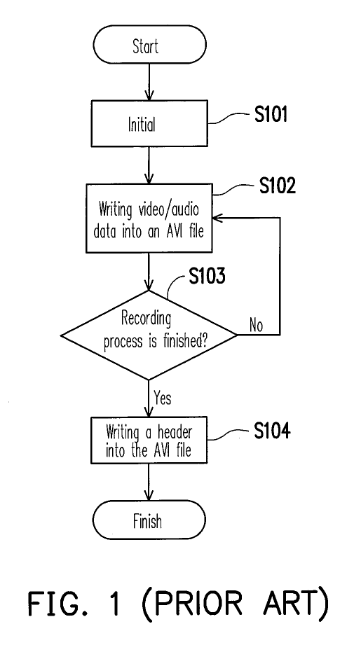

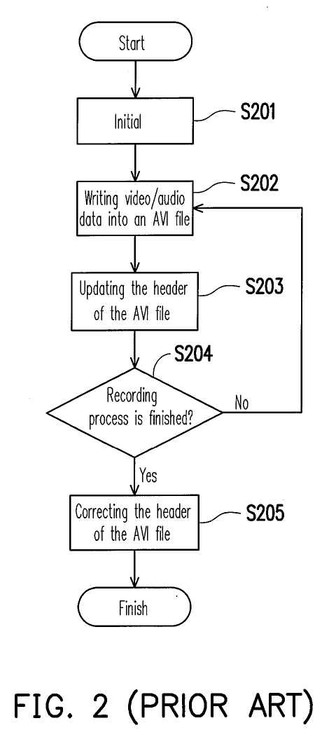

As shown in FIG. 4, if the recording process is terminated abnormally by an interruption, even though it is impossible to get to know the last recorded recording information, the AVI file recorded before the interruption has a complete and legitimate structure, and therefore may be accessed normally. Thereby, compared to the conventional technique as illustrated in FIG. 1, the present embodiment can play the video/audio data recorded before the interruption when the recording process is abnormally terminated, and compared to the conventional technique as illustrated in FIG. 2, the present embodiment has more working efficiency.

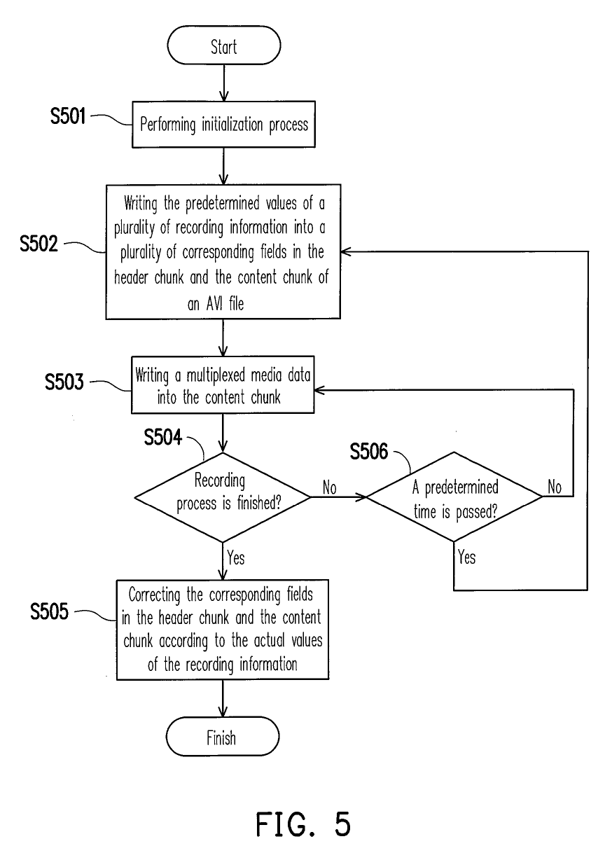

FIG. 5 is a flowchart of an error recovery method for recording an AVI file according to another embodiment of the present invention. In the present embodiment, the recording information recorded in the header chunk 301a and the content chunk 301b is periodically updated by setting a predetermined time T₁. Referring to FIG. 3 and FIG. 5, first, an initialization process is performed to set the initial information of the AVI file (step S501). Next, the predetermined values of a plurality of recording information calculated at a predetermined time T₁ are written into the corresponding fields in the header chunk 301a and the content chunk 301b (step S502), and a multiplexed media data is written into the content chunk 301b to record the AVI file (step S503). In other words, the predetermined values of the recording information written at the beginning are the values of the recording information calculated with at least a T₁.

Thereafter, whether the recording process is finished or not is determined (step S504). If the recording process is finished, the corresponding fields in the header chunk 301a and the content chunk 301b are corrected according to the actual values of the recording information (step S505); otherwise, if the recording process is not finished, then whether a predetermined time T₁ has lapsed or not is determined (step S506). If the predetermined time T₁ has not lapsed, the multiplexed media data is written continuously (step S503). When the predetermined time T₁ has lapsed, the corresponding fields in the header chunk 301a and the content chunk 301b are updated for the first time with a threshold value (step S502), wherein the threshold value is greater than or equal to the values of the recording information calculated with the time needed before the fields are updated next time.

For example, assuming the recording information is a video frame number and the recording system updates the fields every 30 minutes, the predetermined value of the video frame number written into the AVI file for the first time is the value of the video frame number calculated with at least 30 minutes (i.e. greater than or equal to the actual time recorded before the field is updated). Thus, when the recording process is abnormally terminated by an interruption after it has been carried out for some time (for example, 18 minutes), the recording system still can play the video/audio data recorded before the interruption because the video frame number of at least 30 minutes is recorded in the header chunk of the AVI file.

When the recording process has been carried out normally for 30 minutes, the recording system updates the field for the first time. Here, the video frame number calculated with at least 60 minutes (i.e. the total time before the next update) is written into the corresponding field (i.e. the video frame number field in the header chunk 301a) so that the video/audio data recorded within 60 minutes can still be played even an interruption occurs. As described above, in the present embodiment, when the recording system updates for the N^{th} time, the threshold value written into the field is the value of the recording information calculated with at least a time of T₁×(1+N), wherein N is 0 or a positive integer. Accordingly, by updating the recording information periodically, the video/audio data recorded before the recording system is terminated abnormally by an interruption can still be played by the recording system.

It should be noted that the order in which the predetermined values of the recording information (in step S502) and the multiplexed media data (in step S503) are written is not restricted in the present embodiment. In the present embodiment, the predetermined values of the recording information (step S502) written into the AVI file are the values of the recording information calculated at the predetermined time T₁; however, which may also be the maximums values of the recording information specified by the specification of AVI file, greater than or equal to the actual values of the recording information recorded by the recording system, or the maximum values of the recording information which can be recorded by the recording system as described in the description of FIG. 4.

In summary, according to the embodiment of the present invention illustrated in FIG. 4, the predetermined values of the recording information are written into the corresponding fields in the header chunk 301a and the content chunk 301b and the multiplexed media data is also written in order to record the AVI file. Thus, even if the recording process is abnormally terminated by an interruption, the content of the AVI file recorded before the interruption can still be normally accessed for the AVI file has a complete and legitimate structure. According to the embodiment of the present invention illustrated in FIG. 5, during a recording process, the corresponding fields in the header chunk and the content chunk are periodically updated with a value (i.e. the threshold value) of the recording information greater than or equal to the values calculated before next update (for example, T₁×(1+N), wherein T₁ is the predetermined time, and N is the number of updates), so that even if the recording process is abnormally terminated by an interruption, the content of the AVI file recorded before the interruption can still be played. In the foregoing embodiments, the corresponding fields in the header chunk 301a and the content chunk 301b can be selectively corrected according to the actual values of the recording information after the recording process has been finished.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An error recovery method for recording an AVI file, wherein the AVI file comprises a header chunk and a content chunk, the error recovery method comprising:
writing a plurality of predetermined values of recording information into a plurality of corresponding fields in the header chunk and the content chunk, wherein the recording information is related to a video/audio length of the AVI file; and
writing a multiplexed media data into the content chunk to record the AVI file.

2. The error recovery method according to claim 1 further comprising:
correcting the fields in the header chunk and the content chunk respectively according to the actual values of the recording information after the AVI file recording is finished.

3. The error recovery method according to claim 1, wherein the predetermined values of the recording information are the maximum values of the recording information specified by the specification of the AVI file.

4. The error recovery method according to claim 1, wherein the predetermined values of the recording information are greater than or equal to the actual values of the recording information recorded by a recording system.

5. The error recovery method according to claim 1, wherein the predetermined values of the recording information are the maximum values of the recording information recorded by a recording system.

6. The error recovery method according to claim 1 further comprising:
performing an initialization process to set a plurality of initial information of the AVI file.

7. The error recovery method according to claim 1, wherein the AVI file comprises an index chunk, further comprising:
writing the chunk types of a plurality of sub-chunks in the content chunk and the offsets for playing the sub-chunks into the index chunk.

8. The error recovery method according to claim 1, wherein the recording information comprises a video frame number, an audio data sample number, a total frame number, a size of resource interchange file format (RIFF), a size of the content chunk, an audio data sample number, a total frame number, or the combination thereof.

9. An error recovery method for recording an AVI file, wherein the AVI file comprises a header chunk and a content chunk, the error recovery method comprising:
writing a plurality of predetermined values of recording information into a plurality of corresponding fields in the header chunk and the content chunk, wherein the recording information is related to a video/audio length of the AVI file;
writing a multiplexed media data into the content chunk to record the AVI file; and
updating the fields in the header chunk and the content chunk with a threshold value every predetermined time, wherein the threshold value is greater than or equal to the values of the recording information calculated with the time needed before the fields are updated next time.

10. The error recovery method according to claim 9 further comprising:
correcting the fields in the header chunk and the content chunk respectively according to the actual values of the recording information when the AVI file recording is finished.

11. The error recovery method according to claim 9, wherein the predetermined values of the recording information are the maximum values of the recording information specified by the specification of the AVI file.

12. The error recovery method according to claim 9, wherein the predetermined values of the recording information are greater than or equal to the actual values of the recording information recorded by a recording system.

13. The error recovery method according to claim 9, wherein the predetermined values of the recording information are the maximum values of the recording information recorded by a recording system.

14. The error recovery method according to claim 9, wherein the predetermined values of the recording information are the values of the recording information calculated every predetermined time.

15. The error recovery method according to claim 9 further comprising:
performing an initialization process to set a plurality of initial information of the AVI file.

16. The error recovery method according to claim 9, wherein the AVI file comprises an index chunk, further comprising:
writing the chunk types of a plurality of sub-chunks in the content chunk and the offsets for playing the sub-chunks into the index chunk.

17. The error recovery method according to claim 9, wherein the recording information comprises a video frame number, an audio data sample number, a total frame number, a size of resource interchange file format (RIFF), a size of the content chunk, an audio data sample number, a total frame number, or the combination thereof.
